(19) United States
(12) Patent Application Publication
(10) Pub. No.: US 2014/0154511 A1
(43) Pub. Date: Jun. 5, 2014

(54) METHOD OF STRENGTHENING GLASS BY ION IMPLANTATION

(71) Applicants: WINTEK CORPORATION, Taiching City (TW); UNITED WIN (CHINA) TECHNOLOGY LTD, Suzhou City (CN)

(72) Inventors: Chin-Hsun Ho, Taichung City (TW); Chin-Yi Hsu, Taichung City (TW); Jinjin Nan, Nanjing City (CN)

(73) Assignees: WINTEK CORPORATION, Taichung City (TW); UNITED WIN (CHINA) TECHNOLOGY LTD, Suzhou City (CN)

(21) Appl. No.: 14/094,808

(22) Filed: Dec. 3, 2013

(30) Foreign Application Priority Data
Dec. 3, 2012 (CN) 201210509476.9

(51) Int. Cl. C03C 21/00

(52) U.S. Cl. CPC C03C 21/007
USPC 428/410; 65/30.14

(57) ABSTRACT

A method of strengthening glass by ion implantation includes following steps. First, an ion implantation device is provided. The ion implantation device generates a plurality of positive ions and a plurality of negative ions. The positive ions and the negative ions are implanted into a glass substrate by the ion implantation device for strengthening the glass substrate.

### BACKGROUND OF THE INVENTION

1. Field of the Invention

The present invention relates to a method of strengthening glass, and more particularly, to a method of strengthening glass by ion implantation.

2. Description of the Prior Art

Glass materials have been widely applied in many kinds of articles for daily use because of high transparency to light. Glass may be strengthened by many different approaches for being applied in merchandise with higher demand of strength. Generally, the approaches may be divided into physical strengthening processes and chemical strengthening processes. In display and touch panel industries, thin glass substrates are generally strengthened by chemical strengthening process. The glass substrates are dipped into high temperature nitrohydrochloric acid for generating metal ion exchange, and compressed stress may be form on the surface of the glass substrates for strengthening the glass substrates. However, the chemical strengthening process mentioned above is not suitable for strengthening only some specific regions on the glass substrate, and the transparency of the glass substrate may be influenced by the chemical strengthening process. Accordingly, a method of strengthening glass by ion implantation has been developed in related industries.

Please refer to FIG. 1. FIG. 1 is a schematic diagram illustrating a conventional method of strengthening glass by ion implantation. As shown in FIG. 1, in the conventional method of strengthening glass by ion implantation, an ion implantation device 100 including a positive ion source 110 and an accelerator 120 is applied. The positive ion source 110 is used to extract positive ions 110P such as a positive hydrogen ion (H⁺) from gaseous molecules. The positive ions 110P are then implanted into a glass substrate 140 disposed in a process chamber 130 by the accelerator 120 so as to form compressed stress in the glass substrate for strengthening the glass substrate 140. By controlling the implantation condition of the positive ions 110P, the purpose of partially strengthening can be achieved. However, in the method mentioned above, a lot amount of the positive ions 110P also bring a lot amount of positive charges accumulating on the surface of the glass substrate 140 and repelling effect may be generated. The successive positive ions 110P cannot be well implanted into the glass substrate 140 because of the repelling effect, and the ion implantation performance may be seriously affected. In addition, electrostatic discharge may also be a problem generated by the accumulated positive charges. A conductive film 150 may be formed on the surface of the glass substrate 140 and grounded before the ion implantation process so as to take the charges away for avoiding the charge accumulating issue mentioned above. However, the cost of the method of strengthening glass may be increased in this way.

### SUMMARY OF THE INVENTION

It is one of the objectives of the present invention to provide a method of strengthening glass by ion implantation. Positive ions and negative ions are implanted into a glass substrate concurrently to strengthen the glass substrate. Ion repelling issue and electrostatic discharge issue generated by implanting ions with the same charge will be improved accordingly.

To achieve the purposes described above, an embodiment of the present invention provides a method of strengthening glass by ion implantation including following steps. First, an ion implantation device is provided. The ion implantation device generates a plurality of positive ions and a plurality of negative ions. The positive ions and the negative ions are implanted into a glass substrate by the ion implantation device for strengthening the glass substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional method of strengthening glass by ion implantation.

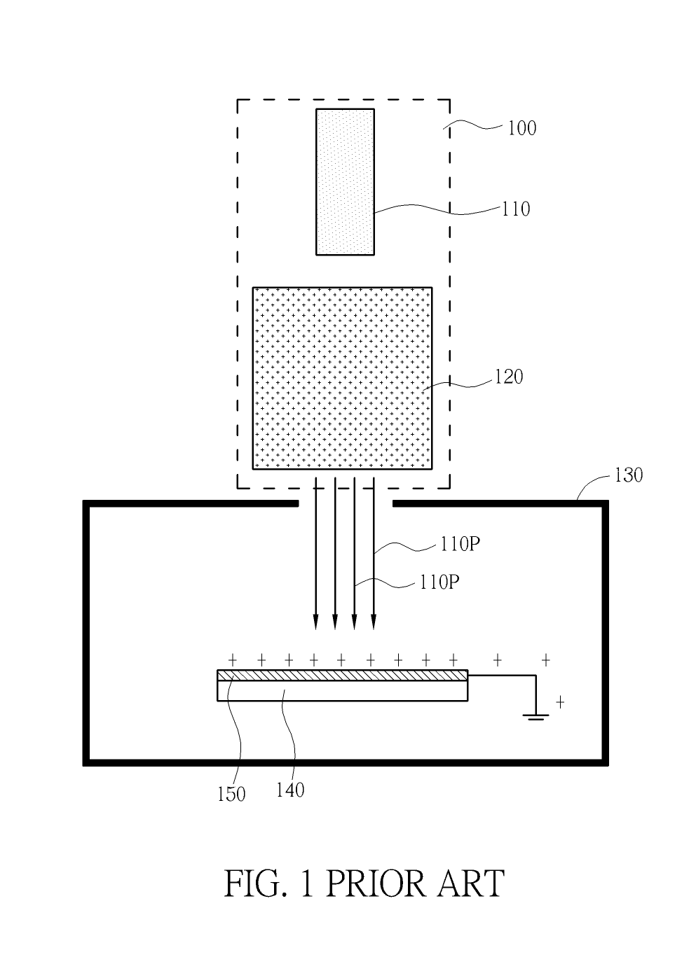

FIG. 2 is a schematic diagram illustrating a method of strengthening glass by ion implantation according to an embodiment of the present invention.

FIG. 3 is a schematic diagram illustrating a method of strengthening glass by ion implantation according to another embodiment of the present invention.

### DETAILED DESCRIPTION

In the following description, numerous specific details are given to provide a thorough understanding of an ion implantation method related to the invention. In addition, reference is made to the accompanying drawings, which form a part hereof, and in which is shown by way of illustration specific examples in which the embodiments may be practiced.

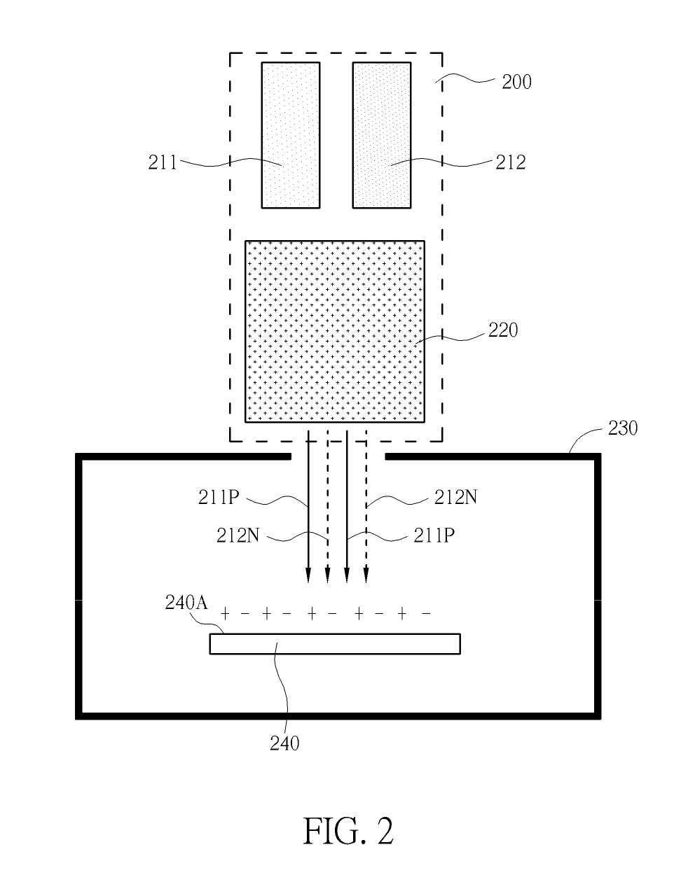

Please refer to FIG. 2. FIG. 2 is a schematic diagram illustrating a method of strengthening glass by ion implantation according to an embodiment of the present invention. Please note that the figures are only for illustration and the figures may not be to scale. The scale may be further modified according to different design considerations. As shown in FIG. 2, the method of strengthening glass by ion implantation in this embodiment includes following steps. First, an ion implantation device 200 is provided. The ion implantation device 200 is used to generate a plurality of positive ions 211P and a plurality of negative ions 212N. The positive ions 211P and the negative ions 212N are implanted into a glass substrate 240 by the ion implantation device 200 for strengthening the glass substrate 240. Because polarities and electrical charges are different between the positive ions 211P and the negative ions 212N implanted in to the glass substrate 240, a compensation effect may be generated so as to avoid repelling issue and electrostatic discharge issue which may be generated by accumulated ions with the same charge and polarity. Additionally, no conductive film is required to be formed on the glass substrate 240 for removing accumulated ions, and cost of the method of strengthening glass by ion implantation in this embodiment may become lower accordingly.

More specifically, the ion implantation device 200 in this embodiment may preferably include a positive ion source 211 and a negative ion source 212, the positive ion source 211 is configured to generate the positive ions 211P, and the negative ion source 212 is configured to generate the negative ions 212N, but not limited thereto. In addition, the ion implantation device 200 may further include an implanting unit 220, and the implanting unit 220 may include an accelerator or a mass spectrometry configured to accelerate and inspect the positive ions 211P and the negative ions 212N, but the present invention is not limited to this. Other appropriate devices for implanting ions may also be disposed in the ion implantation device 200. In this embodiment, a charge-mass ratio of each of the positive ions 211P is substantially equal to a charge-mass ratio of each of the negative ions 212N preferably, and the implanting unit 220 may accelerate each positive ion 211P and each negative ion 212N under an electric field with identical electric potential difference for giving each positive ion 211P and each negative ion 212N nearly the same velocity. The implantation condition of the positive ions 211P and the negative ions 212N may then be effectively controlled and the repelling issue may be improved accordingly. It is worth noting that the present invention is not limited to the condition described above. In other embodiment of the present invention, the charge-mass ratio of each of the positive ions 211P may be close to but not completely equal to the charge-mass ratio of each of the negative ions 212N for strengthening glass by ion implantation.

In other words, each of the positive ions 211P and each of the negative ions 212N in this embodiment may come from one identical atom. For example, the positive ions 211P and the negative ions 212N may be positive hydrogen ions (H⁺) and negative hydrogen ions (H⁻) respectively, positive oxygen ions (O⁺) and negative oxygen ions (O⁻) respectively, or positive helium ions (He⁺) and negative helium ions (He⁻) respectively, but the present invention is not limited to this. In other embodiment of the present invention, each of the positive ions 211P and each of the negative ions 212N may also come from different atoms for ion implantation. Additionally, the glass substrate 240 in this embodiment may have a surface 240A facing the ion implantation device 200, and the positive ions 211P and the negative ions 212N may be implanted into the glass substrate 240 via the surface 240A. An implanting depth of the positive ions 211P and the negative ions 212N in the glass substrate 240 may be controlled by modifying acceleration energies added on the positive ions 211P and the negative ions 212N by the implanting unit 220. Generally, the implanting depth may be decided by possible damages to the glass substrate during other manufacturing processes so as to effectively strengthen the glass substrate, but not limited thereto. In addition, implanting angles and concentrations of the positive ions 211P and the negative ions 212N may also be modified according to other considerations.

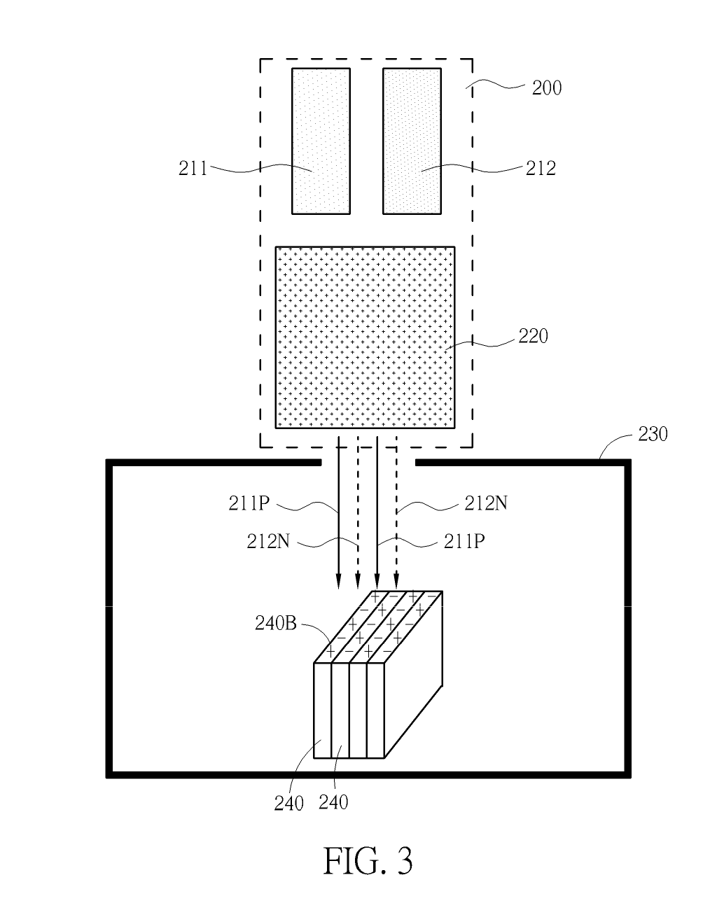

Please refer to FIG. 3. FIG. 3 is a schematic diagram illustrating a method of strengthening glass by ion implantation according to another embodiment of the present invention. As shown in FIG. 3, in the method of strengthening glass by ion implantation of this embodiment, the glass substrate 240 has an edge 240B facing the ion implantation device 200, and the positive ions 211P and the negative ions 212N are implanted into the glass substrate 240 via the edge 240B so as to strengthen the edge 240B of the glass substrate 240 by the ion implantation device 200. More specifically, the method of strengthening glass by ion implantation in this embodiment may include the following steps. First, a plurality of glass substrates 240 are provided. The glass substrates 240 are then stacked, and the edges 240B of the glass substrates 240 are arranged to face the ion implantation device 200. The positive ions 211P and the negative ions 212N may then be implanted into the edges 240B of the glass substrates 240 by the ion implantation device 200, and the edges 240B of the glass substrates 240 may be strengthened accordingly.

Generally, the edge 240B of the glass substrate 240 has weaker strength because the glass substrate 240 is formed by cutting, splitting, or grinding process. The electrostatic discharge issue may become more serious on the edge 240B when implanting ions with the same charge into the glass substrate 240 via the edge 240B. In this embodiment, the edge 240B of the glass substrate 240 may be strengthened by concurrently implanting the positive ions 211P and the negative ions 211N into the substrate 240 via the edge 240B without forming any conductive film, and the electrostatic discharge issue on the edge 240 may also be avoided accordingly. Additionally, in this embodiment, the glass substrates 240 maybe stacked and the edges 240B of the glass substrates 240 may be strengthened by ion implantation at the same time. The process efficiency of the method of strengthening glass by ion implantation may be accordingly enhanced, and the cost of the method of strengthening glass by ion implantation may be reduced accordingly.

To summarize the above descriptions, in the method of strengthening glass by ion implantation of the present invention, the positive ions and the negative ions are concurrently implanted into the glass substrate to strengthen the glass substrate. Because the charge and the polarity of the positive ion is different from the charge and the polarity of the negative ion, the ion repelling issue generated by implanting ions with the same charge and the same polarity will be improved accordingly, and the performance of the ion implantation process may be enhanced. In addition, the electrostatic discharge issue may also be improved by the method of the present invention without forming any conductive film, the cost of the method of strengthening glass by ion implantation may be reduced, and the related product competitiveness may be enhanced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of strengthening glass by ion implantation comprising:
providing an ion implantation device, wherein the ion implantation device generates a plurality of positive ions and a plurality of negative ions; and
implanting the positive ions and the negative ions into at least one glass substrate by the ion implantation device for strengthening the glass substrate.

2. The method of claim 1, wherein a charge-mass ratio of each of the positive ions is substantially equal to a charge-mass ratio of each of the negative ions.

3. The method of claim 1, wherein each of the positive ions and each of the negative ions come from one identical atom.

4. The method of claim 1, wherein each of the positive ions and each of the negative ions come from different atoms.

5. The method of claim 1, wherein the ion implantation device comprises a positive ion source and a negative ion source, the positive ion source is configured to generate the positive ions, and the negative ion source is configured to generate the negative ions.

6. The method of claim 1, wherein the glass substrate has a surface facing the ion implantation device, and the positive ions and the negative ions are implanted into the glass substrate via the surface.

7. The method of claim 1, wherein the glass substrate has an edge facing the ion implantation device, and the positive ions and the negative ions are implanted into the glass substrate via the edge.

8. The method of claim 1, further comprising:
providing a plurality of glass substrates;
stacking the glass substrates; and
implanting the positive ions and the negative ions into edges of the glass substrates by the ion implantation device.

9. A strengthened glass comprising at least two parallel main surfaces and at least one edge surface connected to the main surfaces, wherein one of the main surfaces or the edge surface comprises a plurality of positive ions and a plurality of negative ions.

10. The strengthened glass of claim 9, wherein a charge-mass ratio of each of the positive ions is substantially equal to a charge-mass ratio of each of the negative ions.

11. The strengthened glass of claim 9, wherein each of the positive ions and each of the negative ions come from one identical atom.

12. The strengthened glass of claim 9, wherein each of the positive ions and each of the negative ions come from different atoms.
